(19) United States
(12) Patent Application Publication
(10) Pub. No.: US 2016/0357199 A1
(43) Pub. Date: Dec. 8, 2016

(54) HVAC REGISTER AND MULTIPLE HVAC REGISTER SYSTEM

(71) Applicant: KENNY LOFLAND MATLOCK, MARATHON, FL (US)

(72) Inventor: KENNY LOFLAND MATLOCK, MARATHON, FL (US)

(21) Appl. No.: 14/732,734

(22) Filed: Jun. 7, 2015

(51) Int. Cl. G05D 23/19; G05B 15/02

(52) U.S. Cl. CPC G05D 23/1917; G05B 15/02

(57) ABSTRACT

An HVAC register engages an exhaust end of an air duct exhausting, into a space, conditioned air at a flow rate, and includes a frame member; at least one damper pivotal between an open, closed, and an intermediate state; an actuator having a control arm that moves the damper between states; a controller that signals the actuator to move the control arm; and a user interface that receives temperature data from a user. Such a register can operate in a manual and/or automatic mode. A multiple HVAC register system can include a plurality of HVAC registers communicatively connected together.

### FIELD OF THE INVENTION

The present invention relates to HVAC registers and multiple HVAC register systems.

### BACKGROUND OF THE INVENTION

A Heating Ventilation Air Conditioning (“HVAC”) system generally includes a duct system for distributing conditioned air; a heating, cooling, and/or filtering subsystem for conditioning air; and an air handler operably connected to the duct system. A duct system can include at least one air intake end and at least one exhaust end. An air handler, which includes a fan, draws air into the duct system via the intake end(s) and through the subsystem for conditioning, and then exhausts the conditioned air out of the exhaust end(s).

An exhaust end can include a register for regulating the flow of conditioned air through the exhaust end. Such a register can include one or more dampers that can be manually moved between open and closed positions for such regulating.

### SUMMARY OF THE INVENTION

An object of the present invention is to provide an HVAC register.

Another object of the present invention is to provide a multiple HVAC register system.

Additional objects of the present invention are to provide an HVAC register and a multiple HVAC register system that minimize or obviate at least one deficiency in the prior art.

According to an exemplary embodiment of the present invention, an HVAC register can be operably engaged with an exhaust end of an air duct exhausting, into a space, conditioned air at a flow rate, with such a register including: a frame member; at least one damper; an actuator; a controller; and a user interface.

In an exemplary aspect of the present invention, a frame member can have an inner surface, an outer surface, and at least one frame aperture positioned through the inner and outer surfaces.

In another exemplary aspect, a damper can be attached to the frame member, and can be pivotal between an open state, in which the damper exposes the at least one frame aperture, and a closed state, in which the at least one damper covers the at least one frame aperture and restricts the flow rate.

In a further exemplary aspect, an actuator can be connected, directly or indirectly, to the frame member, can include a control arm pivotally connected to one or more dampers, and can be configured to move the control arm to pivot the at least one damper to the open position, the closed position, and an intermediate position between the opened and closed positions.

In still another exemplary aspect, a controller can be communicatively connected to the actuator, and can be configured to signal the actuator to move the control arm.

In still a further exemplary aspect, a user interface can include an input device to receive, from a user, temperature data associated with the space, with the user interface being communicatively connected to the controller and configured to communicate the temperature data to the controller.

In still another exemplary aspect, based at least on the temperature data, the controller can signal the actuator to move the control arm and pivot a damper towards the open or closed positions to change the flow rate of the conditioned air.

In another exemplary embodiment of the invention, a multiple HVAC register system can include a plurality of registers configured to respectively and operably engage respective exhaust ends of respective air ducts exhausting, into respective spaces, conditioned air at respective flow rates, with each of the registers comprising: a frame member; at least one damper; an actuator; a controller; and a user interface.

In an exemplary aspect of a multiple HVAC register system, first and second registers can be communicatively connected together via one or more wired and/or wireless communication channels, the first register can communicate temperature data to the second register, and based at least on the temperature data, the second register controller can signal the second register actuator to move the second register control arm and pivot the at least one second register damper towards one of the second register open position and the second register closed position.

In another exemplary aspect of a multiple HVAC register system, first, second, and third registers can be communicatively connected together via one or more wired and/or wireless communication channels, first, second, and third register identifiers can be respectively associated with the first, second, and third registers, the first register can communicate temperature data and the second register identifier to the second register, and based at least on the temperature data and the second register identifier, the second register controller can signal the second register actuator to move the second register control arm and pivot the second register damper towards the one of the second register open position and the second register closed position.

One or more of the following optional exemplary aspects can be applied to any of the embodiments of the present invention:
an input device can be further configured to receive HVAC state data from a user, and a user interface can be further configured to send the HVAC state data to a controller, such that based at least on the temperature data and the HVAC state data, the controller can signal the actuator to move the control arm and pivot the at least one damper towards one of the open and closed positions to change the flow rate of the conditioned air;
an HVAC register can further include a register temperature sensor that measures a conditioned temperature of the conditioned air, with the register temperature sensor being communicatively connected to the controller, such that based at least on the temperature data and the conditioned temperature, the controller can signal the actuator to move the control arm and pivot the at least one damper towards one of the open and closed positions to change the flow rate of the conditioned air;
a controller can be communicatively connected to a main HVAC system to receive HVAC state data from the main HVAC system, and based at least on temperature data and the HVAC state data, the controller can signal the actuator to move the control arm and pivot the at least one damper towards one of the open and closed positions to change the flow rate of the conditioned air;
portions of the present invention can be connected via one or more hardwired or wireless communication channels;
a user interface can be embodied in a remote control located within the space, and can include an interface temperature sensor that measures an ambient temperature of the space;
the input device can be further configured to receive schedule data from the user, and based at least on the temperature data and the schedule data, said controller signals said actuator to move the control arm and pivot the at least one damper towards one of the open and closed positions to change the flow rate of the conditioned air; and
the frame element can further have at least one frame extension connected thereto having an extension flange configured to engage an exhaust end such that at least a portion of the frame element is positioned within the air duct.

These and other exemplary aspects are described herein.

### BRIEF DESCRIPTION OF THE DRAWINGS

FIG. 1a illustrates an exemplary embodiment of an HVAC register positioned at an exhaust end of an air duct.

FIG. 1b illustrates, from a top-down perspective, an exemplary engagement of an exemplary register with an exhaust end having a wall covering framed around an opening of the exhaust end.

FIG. 1c illustrates an exemplary HVAC register having an actuator with a control arm connected to an exemplary damper.

FIG. 2a illustrates an exemplary HVAC register positioned at least partially within an air duct.

FIG. 2b illustrates, from a top-down perspective, another exemplary engagement of an exemplary register with an exhaust end having a wall covering framed around an opening of the exhaust end.

FIG. 2c illustrates another exemplary HVAC register having an actuator with a control arm connected to an exemplary damper.

FIG. 3a illustrates an exemplary multiple register system in which a first register can communicate received temperature data to a second register.

FIG. 3b illustrates another exemplary multiple register system in which a first register can communicate received temperature data and a received second register identifier to a second register.

FIG. 4 illustrates an exemplary controller having a processor and a memory, in which the controller can signal an actuator based on information provided from a user interface, an interface temperature sensor, and a register temperature sensor.

### DETAILED DESCRIPTION

This disclosure includes a plurality of embodiments each having plural elements and/or aspects, which should not necessarily be interpreted as being conjunctively required by one or more of the embodiments. In particular, all combinations of elements and/or aspects can enable a separate embodiment of the present invention claimable with particularity in this or any future filed patent applications.

Moreover, such elements and/or aspects are to be construed strictly as illustrative and enabling, and not necessarily limiting. Further, to the extent an element and/or aspect is defined differently anywhere within this disclosure, whether expressly or implicitly, the broader definition is to take absolute precedence, with the distinctions encompassed by the narrower definition to be construed as optional.

Perceived benefits of the present invention can include HVAC performance improvements and efficiencies, and additional functional utility expressly and implicitly stated herein or apparent herefrom.

The present invention provides an HVAC register, and a multiple HVAC register system.

The present invention can be formed, in whole or in part, from any one or more desired materials that are functionally compatible with the present invention as described. Thus, any one or more of a plastic, rubber, metal, wood, elastomer, crystalline material, man-made material, and naturally-occurring material may be utilized insofar as the resulting material renders the invention functional within the spirit of the invention.

Further, any embodiment of the present invention can provided in any functionally compatible size and/or shape, which can include predetermined sizes and shapes to compatibly engage ducts having predetermined sizes and shapes.

An exemplary environment of the present invention includes an HVAC system having a duct system that includes at least one air duct having an exhaust end through which conditioned air is exhausted into a space at a flow rate.

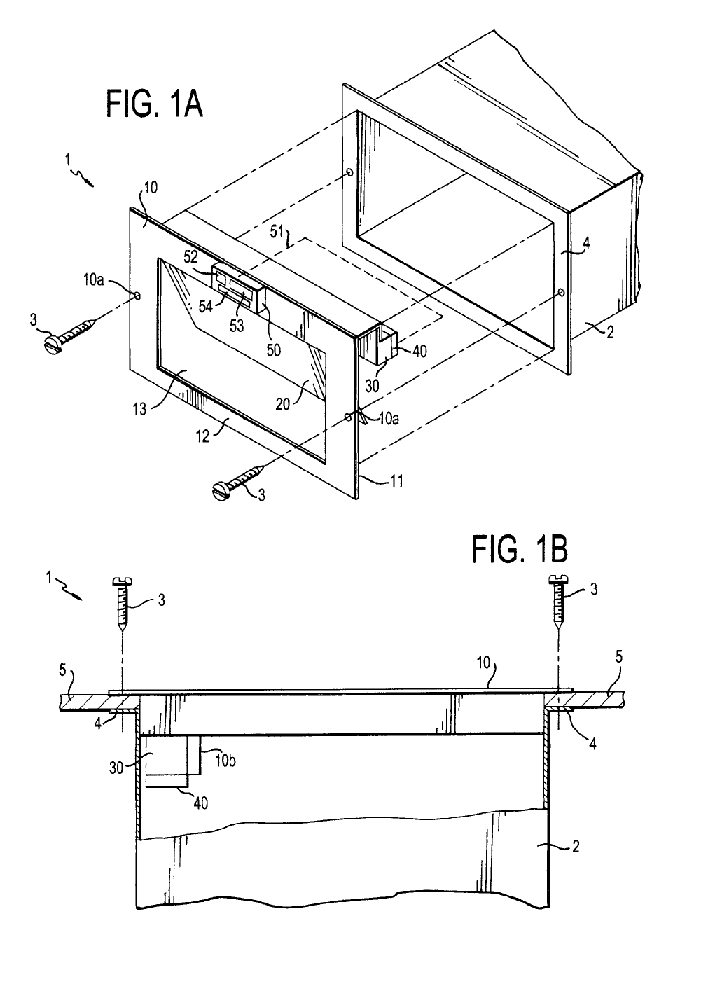

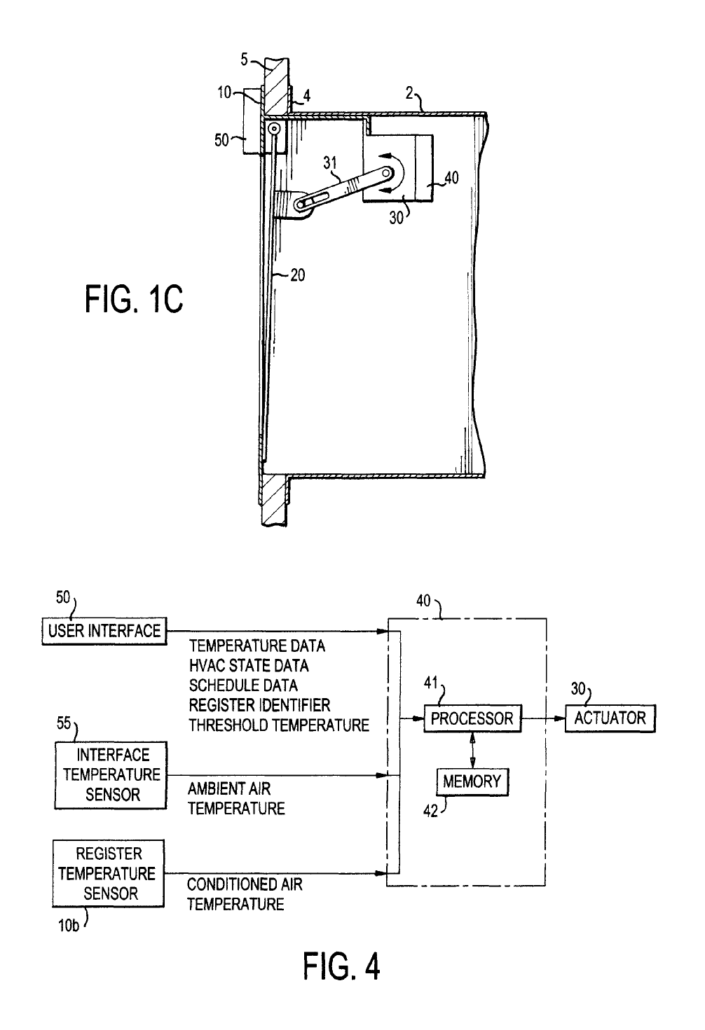

According to the present invention, an HVAC register 1 can be configured so as to be positioned at an exhaust end 2 of an air duct, as illustrated in FIG. 1a, or positioned at least partially within an air duct, as illustrated in FIG. 2a.

In either configuration, an exemplary HVAC register 1 can include a frame member 10; at least one damper 20; an actuator 30 (see FIGS. 1c and 2c); a controller 40; and a user interface 50.

As illustrated in FIGS. 1a and 2a, frame member 10 includes an inner surface 11, an outer surface 12, and at least one frame aperture 13 extending through the inner and outer surfaces. In an exemplary aspect, frame member 10 can be provided with a substantially planar profile, as illustrated, but can deviate in shape and be provided with any one or more desired shapes, insofar as functionally compatible with the present invention as described.

As further illustrated, frame member 10 can engage an exhaust end 2 to orient register 1 such that inner surface 11 faces the exhaust end, outer surface 12 faces outwardly, and conditioned air (not shown) exhausted from the exhaust end flows through frame aperture 13. In an exemplary aspect, frame member 10 can be operably engaged with any portion of exhaust end 2, which can include any structure adjacent or connected thereto, in any functionally compatible manner that aligns frame aperture 13 with the exhaust end. For example and not in limitation, operable engagement can be effectuated via a friction fit between frame member 10 and exhaust end 2, and/or via one or more clamps, screws, magnets, adhesives, or any other known or apparent structure that operably engages the frame member with the exhaust end as described herein. For example, as illustrated in FIGS. 1a and 2a, frame element 10 can include optional engagement apertures 10a to respectively accommodate a pair of screws 3 to engage the frame element to a duct flange 4 of exhaust end 2. As illustratively shown in FIG. 2a, frame member 10 can optionally include at least one frame extension 14 extending therefrom and having an extension flange 14a with engagement aperture 10a provided therethrough, with such an extension(s) allowing positioning of the frame member within exhaust end 2.

FIG. 2a further illustrates an optional auxiliary register 6, which can include a pair of screw apertures 6a to accommodate screws 3, such that the screws can engage exhaust end 2 with the auxiliary register and HVAC register 1 securably disposed therebetween. As further illustrated, auxiliary register 6 can be provided with at least one auxiliary register dampers 6b to modify air flow as desired.

FIGS. 1b and 2b illustrate, from a top-down perspective, exemplary engagements of register 1 with an exhaust end 2. As illustrated, an exemplary environment can optionally include a wall covering 5 (such as gypsum board, for example and not in limitation) framed around an opening of exhaust end 2. In exemplary embodiments of the present invention, as illustrated in FIG. 1b, screws 3 can pass through frame member 10 and engage exhaust end 2 with wall covering 5 disposed between the frame member and the exhaust end; and as illustrated in FIG. 2b, the screws can pass through the frame member and extension flanges 14a and engage the exhaust end with the wall covering disposed between the frame member and the extension flanges. FIGS. 1b and 2b further illustrate an optional register temperature sensor 10b, which can measure the temperature of conditioned air passing through aperture 13 and provide the measured temperature to controller 40 (further described infra) via a hardwired or wireless communication channel. Notably, sensor 10b is illustratively shown as being attached to actuator 30, but can be attached to any functionally compatible portion of register 1 or any structure adjacent thereto, such as exhaust end 2. Further, sensor 10b can be integrated with any other element of the present invention, such as with controller 40.

As illustrated in FIGS. 1a and 2a, register 1 further includes at least one damper 20 moveably attached to frame member 10, which can be effectuated by any type of functionally compatible hinge or pivot structure. In an exemplary aspect, damper 20 can be pivotal between a closed state, in which the at least one damper is generally parallel to frame aperture 13 so as to cover the frame aperture, which can restrict the flow rate; and an open state, in which the damper is pivoted towards a position perpendicular to frame aperture 13, so as to create a minimal restriction of the flow rate. Notably, damper 20 can be pivoted to an intermediate state between the open and closed states to selectively restrict the air flow by a desired amount. Also notably, the open and closed states need not be exact due to design considerations, design constraints, and particular desirability.

As further illustrated in FIGS. 1c and 2c, register 1 can also includes an actuator 30, which can be attached to frame member 10 either directly or indirectly (e.g., via a bracket or other intermediate structure, including exhaust end 2 or control arm 31). Further, actuator 30 can include a control arm 31 moveably connected to damper 20, and upon receipt of a control signal (further described, infra), which can include any combination of one or more analog or digital signals, the actuator can move the control arm to move damper 20 to an open position, a closed position, or one or more intermediate positions between the opened and closed positions. Notably, actuator 30 is illustratively shown as a servomotor, but can be provided as a stepper motor or any other functionally compatible motor or mechanism capable of moving control arm 31 to move damper 20 in a manner functionally compatible with the present invention. In particular, functionally compatible movement can include linear and/or curvilinear motion.

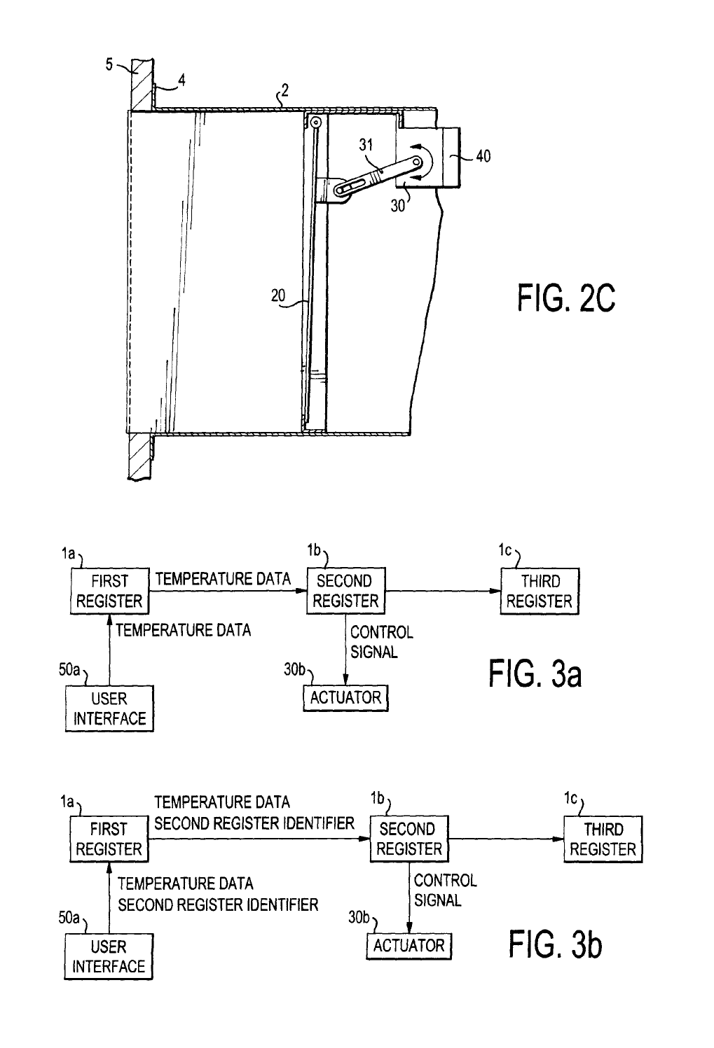

As also illustrated in FIGS. 1c and 2c, register 1 can further includes a controller 40, which can optionally be attached, directly or indirectly, to frame member 10. Notably, controller 40 can be attached to any portion of, or provided adjacent to, or in association with (e.g., communicatively connected), register 1. Further, controller 40 can be provided as any one or more functionally compatible structures including, but not limited to, any combination of one or more of logic circuitry, a hardwired circuit, an integrated circuit, processor, firmware, clock generator, and computer memory to the extent desired. As illustrated in FIG. 4, controller 40 can generally include a processor 41 and a memory 42, which can be separate elements or integrated together. Notably, processing duties of the present invention can be exclusive to a single controller 40, or can be distributed across one or more elements of the present invention. In an exemplary aspect, controller 40 can be provided adjacent to actuator 30, as illustratively shown, or integrated therewith (e.g., the controller and actuator can be provided within a single housing). Further, at least a portion of the functionality of controller 40 can optionally be provided with user interface 50 (infra). In another exemplary aspect, controller 40 can be communicatively connected to actuator 30 and user interface 50 via one or more hardwired or wireless communication channels, and is configured to signal the actuator to move control arm 31 to pivot damper 20 to the open position, the closed position, or to one or more intermediate positions.

In still another exemplary aspect, register 1 can further includes a user interface 50 communicatively connected to controller 40, which can be via a hardwired or wireless connection. In a further exemplary aspect, communication between controller 40 and user interface 50 can be initiated by either the controller or the user interface, and can be effectuated on an on-demand or periodic basis. User interface 50 can include an input device 52, and optionally, an output device 53. Input device 52 can include any combination of one or more buttons, switches, dials, slides, and tactile devices configured to accept input data from a user. Output device 53 can include any combination of at least one of a visual, auditory, and tactile device configured to convey output information, such as conveying to a user a present state of register 1, input data provided by the user, etc., with such output device including any one or more of a display screen, speaker, light device, buzzer, etc. Notably, user interface 50 can be attached to any portion of, or provided adjacent to, or in association with (e.g., communicatively connected), register 1, or can be embodied in a remote control 50 as illustrated in FIG. 2a. Further notably, it will be apparent to one of ordinary skill that any data instance described herein can be stored in any one or more storage devices (including but not limited to any static, dynamic, analog, and digital device) and can be provided with any portion of the present invention, including, but not limited to, controller 40 and/or user interface 50.

In an exemplary aspect, input data can include temperature data. Optionally, input data can further include at least one of HVAC state data, schedule data, and/or a register identifier.

In another exemplary aspect, temperature data can represent a positional value corresponding to a desired position of damper 20 (such as closed, position 1, position n, open, for example and not in limitation); or a desired temperature value (such as 76° F., 78° F., 24° C., etc., for example and not in limitation).

In an exemplary aspect, HVAC state data can represent whether a main HVAC system is in a cooling state (i.e., the system is cooling the air) or a heating state (i.e., the system is heating the air). In another exemplary aspect, schedule data can include a start time, which can represent at least one of a time, day, and/or date. Further, schedule data can include either an end time or a duration value representing how long a scheduled event is to be executed. Further, schedule data can additionally include mode data, which can represent at least one of a daily, a weekly, and an ad-hoc schedule state. In a further exemplary aspect, a register identifier can uniquely represent at least one specific HVAC register for which provided temperature data pertains or impacts.

As illustrated in FIG. 4, via user interface 50, controller 40 can receive temperature data as well as optional data, including any combination of HVAC state data, schedule data, a register identifier, and a threshold temperature. As further illustrated, via an optional interface temperature sensor 55, controller 40 can receive an ambient air temperature. As additionally illustrated, via optional register temperature sensor 10b, controller 40 can receive a conditioned air temperature. Processor 41 can effectuate the temperature data and any additional data provided and accordingly provide actuator 30 with one or more corresponding signals. Notably, memory 42 can be utilized to store any data required for processing, including non-volatile storage for subsequent utilization thereof.

In an exemplary embodiment, register 1 can be configured to operate in a manual mode and/or an automatic mode.

In an exemplary manual mode, a user can provide temperature data representative of a positional value via user interface 50, which communicates the temperature data to controller 40. Based on the temperature data, controller 40 can signal actuator 30 to move control arm 31, which in turn moves damper 20 to a particular damper position based, at least in part, on the temperature data. As noted above, a particular damper position can be open, closed, or one or more intermediate positions therebetween.

The present invention can alternatively or additionally include an automatic mode, in which a controller can render a determination as to whether to open, close, or further open or close damper 20. Notably, such a determination can be effectuated based on a schedule, a condition (e.g., a received request from a user interface, etc.), or a time period (e.g., every 5 minutes, etc.).

According to an exemplary automatic mode, a user can configure register 1 to automatically adjust the temperature of the space into which register 1 provides conditioned air according to a desired temperature. In an exemplary aspect, a user can provide temperature data representative of a desired temperature value of a space via user interface 50, which communicates the temperature data to controller 40. Further, user interface 50 further includes an optional interface temperature sensor 55, which can measure and provide an ambient temperature of the space to controller 40. Accordingly, if the ambient temperature deviates from the temperature data, controller 40 can open, close, or further open/close damper 20 to increase or decrease the air flow of the conditioned air to change the ambient temperature towards the desired temperature. Notably, whether to open or close (or further open/close) damper 20 will depend on whether a main HVAC system is in a cooling or heating state, which controller 40 can determine based on HVAC state data. As noted above, HVAC state data can be provided by the user via user interface 50, either manually or by a default setting. However, alternatively, controller 40 can obtain HVAC state data from a main HVAC system (via an air handler, system thermostat, etc.) or can determine the HVAC state data based on a comparison of a measured conditioned air temperature of the conditioned air via an optional register temperature sensor 10b and a threshold temperature. In an exemplary aspect, a threshold temperature can be any suitable predetermined value, such as 64° F. for example and not in limitation, can be user-defined via user interface 50, or can be factory defined. Alternatively, controller 40 can set a threshold value at an ambient air temperature measured by interface temperature sensor 55. Accordingly, if a conditioned air temperature is less than a threshold temperature, controller 40 can determine the HVAC state data as representing a cooling state, and if the conditioned air temperature is greater than the threshold temperature, controller 40 can determine the HVAC state data as representing a heating state.

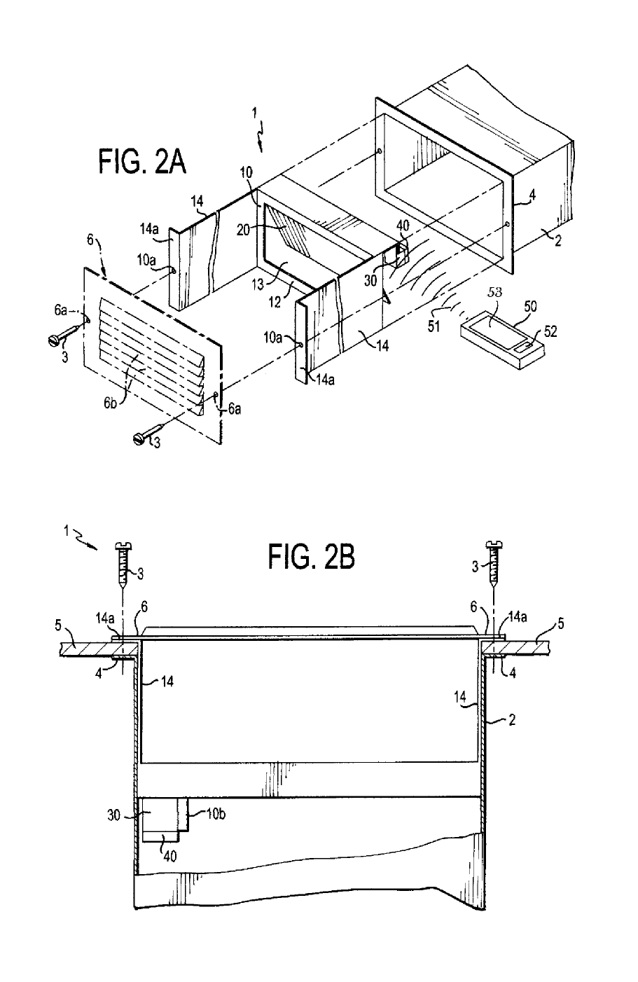

In a multiple register environment, a user can configure a particular register 1 to automatically adjust the temperature of the space, into which the particular register 1 provides conditioned air, according to a desired temperature. As illustrated in FIG. 3a, via a first user interface 50a associated with a first register 1a, a user can provide temperature data communicated to the first register, which can communicate the temperature data to a second register 1b, which can effectuate the processing of the temperature data via communication of a corresponding signal to a second actuator 30b.

In an exemplary aspect, optionally, a user can additionally provide a register identifier (which uniquely identifies a particular register) with which the desired temperature (or other user input) is associated, and a controller associated with the particular register can process the user input. As illustrated in FIG. 3b, via a first user interface 50a associated with a first register 1a, a user can provide temperature data and a second register identifier that are communicated to the first register, which can forward this information to a second register 1b, which can effectuate the processing thereof via communication of a corresponding signal to a second actuator 30b. Accordingly, in a multiple HVAC register system, a register may receive user input associated with a different register, which can be apparent when that register receives a register identifier that does not match its register identifier. Thus, at least one register 1 in a multiple register system can optionally include a relay function in which it communicates received user input and a received register identifier that deviates from its register identifier to one or more registers communicatively connected to the at least one register.

It will be apparent to one of ordinary skill in the art that the manner of making and using the claimed invention has been adequately disclosed in the above-written description of the exemplary embodiments and aspects.

It should be understood, however, that the invention is not necessarily limited to the specific embodiments, aspects, arrangement, and components shown and described above, but may be susceptible to numerous variations within the scope of the invention.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents of the appended claims.

Therefore I claim:

1. An HVAC register for operable engagement with an exhaust end of an air duct exhausting, into a space, conditioned air at a flow rate, said register comprising:
a frame member having an inner surface, an outer surface, and at least one frame aperture extending through the inner and outer surfaces;
at least one damper, attached to said frame member, and pivotal between an open state, in which the at least one damper exposed the at least one frame aperture, and a closed state, in which the at least one damper covers the at least one frame aperture and restricts the flow rate;
an actuator connected to said frame member, and having a control arm pivotally connected to said at least one damper, said actuator configured to move the control arm to pivot the at least one damper to the open position, the closed position, and an intermediate position between the opened and closed positions;
a controller, communicatively connected to said actuator, and being configured to signal said actuator to move the control arm; and
a user interface having an input device configured to receive from a user temperature data associated with the space, said user interface being communicatively connected to said controller and configured to communicate the temperature data to said controller;
wherein said frame element is configured to engage at least one of the respective exhaust end and a wall covering adjacent to the exhaust end, and based at least on the temperature data, said controller signals said actuator to move the control arm and pivot the at least one damper towards one of the open and closed positions so as to change the flow rate of the conditioned air.

2. The HVAC register of claim 1, wherein the input device is further configured to receive HVAC state data from the user, said user interface is further configured to send the HVAC state data to said controller, and based at least on the temperature data and the HVAC state data, said controller signals said actuator to move the control arm and pivot the at least one damper towards one of the open and closed positions so as to change the flow rate of the conditioned air.

3. The HVAC register of claim 1, further comprising:
a register temperature sensor that measures a conditioned temperature of the conditioned air, said register temperature sensor being communicatively connected to said controller;
wherein based at least on the temperature data and the conditioned temperature, said controller signals said actuator to move the control arm and pivot the at least one damper towards one of the open and closed positions to change the flow rate of the conditioned air.

4. The HVAC register of claim 1, wherein said controller is communicatively connected to a main HVAC system to receive HVAC state data from the main HVAC system, and based at least on the temperature data and the HVAC state data, said controller signals said actuator to move the control arm and pivot the at least one damper towards one of the open and closed positions so as to change the flow rate of the conditioned air.

5. The HVAC register of claim 1, wherein said controller and said user interface are connected via a wireless communication channel.

6. The HVAC register of claim 5, wherein said user interface is embodied in a remote control located within the space, and includes an interface temperature sensor that measures an ambient temperature of the space, and based at least on the temperature data and the ambient temperature, said controller signals said actuator to move the control arm and pivot the at least one damper towards one of the open and closed positions so as to change the flow rate of the conditioned air.

7. The HVAC register of claim 1, wherein the input device is further configured to receive schedule data from the user, and based at least on the temperature data and the schedule data, said controller signals said actuator to move the control arm and pivot the at least one damper towards one of the open and closed positions so as to change the flow rate of the conditioned air.

8. The HVAC register of claim 1, wherein said frame element further has at least one frame extension having an extension flange, and when the extension flange is engaged with the at least one of the exhaust end and a wall covering, at least a portion of said frame element is positioned within the air duct.

9. The HVAC register of claim 1, wherein when said frame element is engaged with the at least one of the exhaust end and a wall covering, the outer surface is positioned outside of the air duct.

10. A multiple HVAC register system, comprising a plurality of registers configured to respectively and operably engage respective exhaust ends of respective air ducts exhausting, into respective spaces, conditioned air at respective flow rates, with each of said registers comprising:
a frame member having an inner surface, an outer surface, and at least one frame aperture extending through the inner and outer surfaces, the frame member being configured to engage at least one of the respective exhaust end and a respective wall covering adjacent to the respective exhaust end;
at least one damper, attached to the frame member, and pivotal between an open state, in which the at least one damper exposes the at least one frame aperture, and a closed state, in which the at least one damper covers the at least one frame aperture and restricts the respective flow rate;
an actuator connected to the frame member, and having a control arm pivotally connected to the at least one damper, the actuator configured to move the control arm to pivot the at least one damper to the open position, the closed position, and an intermediate position between the opened and closed positions;
a controller, communicatively connected to the actuator, and being configured to signal the actuator to move the control arm and pivot the at least one damper towards one of the open and closed positions to change the respective flow rate of the conditioned air;
a user interface having an input device configured to receive from a user temperature data, the user interface being communicatively connected to the controller and configured to send the temperature data to the controller;
wherein said plurality of registers include first and second registers communicatively connected together via at least one communication channel, the first register communicates particular temperature data to the second register, and based at least on the particular temperature data, the second register controller signals the second register actuator to move the second register control arm and pivot the at least one second register damper towards one of the second register open position and the second register closed position.

11. The multiple HVAC register system of claim 10, wherein said plurality of registers include first, second, and third registers, communicatively connected together via at least one communication channel, and respectively including first, second, and third register identifiers respectively associated therewith, the first register communicates temperature data and the second register identifier to the second register, and based at least on the particular temperature data and the second register identifier, the second register controller signals the second register actuator to move the second register control arm and pivot the second register damper towards the one of the second register open position and the second register closed position.
